(19) United States
(12) Patent Application Publication
(10) Pub. No.: US 2024/0283278 A1
(43) Pub. Date: Aug. 22, 2024

(54) POWER DEVICE

(71) Applicant: HONDA MOTOR CO., LTD., Tokyo (JP)

(72) Inventor: Masaya Takahashi, Tokyo (JP)

(21) Appl. No.: 18/442,242

(22) Filed: Feb. 15, 2024

(30) Foreign Application Priority Data
Feb. 21, 2023 (JP) 2023-024868

(51) Int. Cl. H02J 7/14; H02J 7/02

(52) U.S. Cl. CPC H02J 7/14; H02J 7/02; H02J 2207/20

(57) ABSTRACT

A power device includes a power storage device, a rotating electric machine, an AC charging and power supply unit, a DC-DC converter, a power conversion unit, and a power supply unit. The AC charging and power supply unit is connected to the rotating electric machine. The DC-DC converter is connected to the power storage device. The power conversion unit is connected between the DC-DC converter and the rotating electric machine. The power supply unit is connected to the DC-DC converter and the power conversion unit.

### CROSS-REFERENCE TO RELATED APPLICATION

Priority is claimed on Japanese Patent Application No. 2023-024868, filed Feb. 21, 2023, the content of which is incorporated herein by reference.

### BACKGROUND OF THE INVENTION

### Field of the Invention

The present invention relates to a power device.

### Description of Related Art

In recent years, in order to ensure access to affordable, reliable, sustainable, and advanced energy for more people, research and development have been carried out on charging and power supply in mobility devices equipped with secondary batteries that contribute to energy efficiency.

In the related art, a charging system in which a three-phase motor and an inverter that transmit and receive power to and from a power storage device that is charged by an external power source function as a power factor correction (PFC) circuit is known (for example, see Japanese Unexamined Patent Application, First Publication No. 2016-149921).

In the related art, a charging device in which a power factor correction (PFC) circuit provided for AC charging is operated to step up the voltage during DC charging is known (for example, see U.S. Pat. No. 1,116,5349).

### SUMMARY OF THE INVENTION

In the technology related to charging and power supply in mobility devices equipped with secondary batteries, the challenge is to properly provide each function of AC charging from the outside, AC power supply to the outside, and AC power supply within the mobility devices while suppressing the complexity of the system configuration.

For example, the charging system of the related art described above can support single-phase AC charging, but cannot support three-phase AC charging. There is no description of the function of AC power supply, and the voltage of the power storage device cannot be stepped down. In order to realize in-vehicle power supply, an additional unit is required, resulting in a complicated system configuration.

For example, according to the charging device of the related art described above, in a case where charging is performed with more power than the allowable power of the AC charging circuit during DC charging, it is necessary to carry out allowable power design (thermal design) more than in AC charging, which may increase the cost required for the device configuration.

Aspects of the present invention have been made in view of the above problems, and an object of the present invention is to provide a power device that can ensure proper charging and power supply operations while suppressing the device configuration from becoming complicated. This in turn contributes to energy efficiency.

In order to solve the above problems and achieve the above object, the present invention has employed the following aspects.
(1) A power device according to an aspect of the present invention includes: a power storage unit; a rotating electric machine; a charging and power supply unit connected to the rotating electric machine; a DC voltage conversion unit connected to the power storage unit; a power conversion unit connected between the DC voltage conversion unit and the rotating electric machine; and a power supply unit connected to the DC voltage conversion unit and the power conversion unit.
(2) In the above (1), in a case where the power storage unit is charged from the charging and power supply unit by an external power source, the rotating electric machine and the power conversion unit may perform a voltage step-up operation, and the DC voltage conversion unit may perform a voltage step-down operation.
(3) In the above (2), in a case where the power storage unit is charged from the charging and power supply unit by an external power source, the power supply unit may step down a voltage obtained through the voltage step-up operation of the rotating electric machine and the power conversion unit and may supply power to the outside.
(4) In the above (1), in a case where power is supplied to the outside from the charging and power supply unit with power of the power storage unit, the rotating electric machine, the power conversion unit, and the DC voltage conversion unit may perform a voltage step-down operation.
(5) In the above (4), in a case where power is supplied to the outside from the charging and power supply unit with power of the power storage unit, the power supply unit may step down a voltage obtained through the voltage step-down operation of the DC voltage conversion unit and may supply power to the outside.

According to the above (1), charging of the power storage unit from the external power source or the like is performed by the charging and power supply unit via the rotating electric machine, the power conversion unit, and the DC voltage conversion unit, and power supply from the power storage unit to the outside is performed by each of the charging and power supply unit and the power supply unit via the DC voltage conversion unit. Power can be supplied by the power supply unit both during charging and power supply by the charging and power supply unit, and it is possible to ensure proper charging and power supply operations while suppressing the complexity of the device configuration.

In the case of the above (2), since the DC voltage conversion unit sets a voltage suitable for charging the power storage unit through the voltage step-down operation, the charging power amount can be increased by relatively increasing the input voltage of the DC voltage conversion unit.

In the case of the above (3), with the voltage obtained through the voltage step-up operation of the rotating electric machine and the power conversion unit, the power storage unit can be charged after the voltage is stepped down via the DC voltage conversion unit, the voltage can be stepped down and supplied by the power supply unit, and it is possible to properly ensure the charging operation by the charging and power supply unit and the power supply operation by the power supply unit.

In the case of the above (4), since the DC voltage conversion unit sets a voltage suitable for the input to the rotating electric machine and the power conversion unit through the voltage step-down operation, the amount of power supplied can be increased by relatively increasing the input voltage of the DC voltage conversion unit.

In the case of the above (5), with the voltage obtained through the voltage step-down operation of the DC voltage conversion unit, the power can be supplied from the charging and power supply unit to the outside after the voltage is stepped down via the rotating electric machine and the power conversion unit, the voltage can be stepped down and supplied by the power supply unit, and it is possible to properly ensure the power supply operation by each of the charging and power supply unit and the power supply unit.

### BRIEF DESCRIPTION OF THE DRAWINGS

FIG. 1 is a configuration diagram of a power device in an embodiment of the present invention.

FIG. 2 is a diagram showing an AC charging state of the power device according to the embodiment of the present invention.

FIG. 3 is a diagram showing an AC power supply state of the power device according to the embodiment of the present invention.

### DETAILED DESCRIPTION OF THE INVENTION

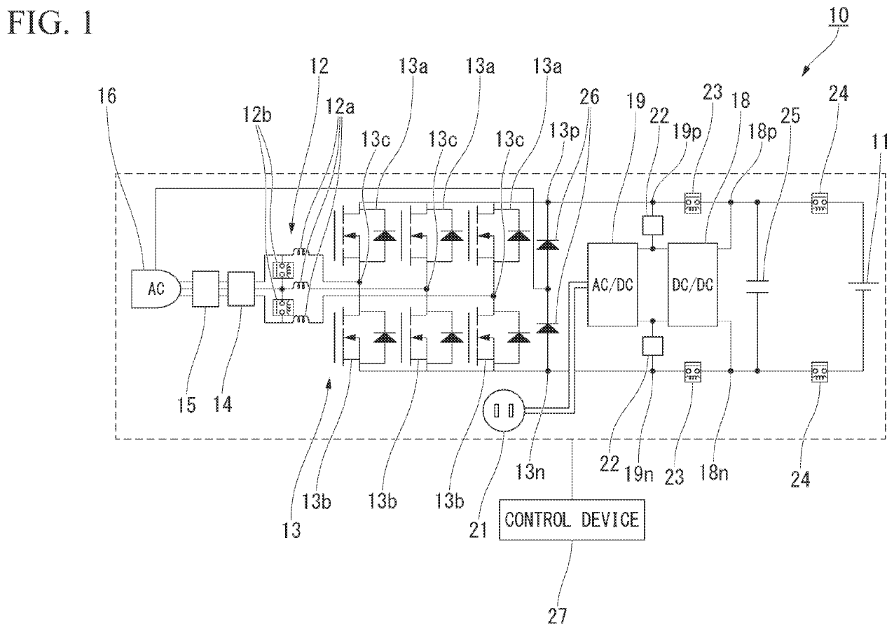

Hereinafter, a power device according to an embodiment of the present invention will be described with reference to the accompanying drawings. FIG. 1 is a configuration diagram of a power device 10 in the embodiment.

The power device 10 of the embodiment is mounted in a vehicle such as an electrically driven vehicle, for example. Electrically driven vehicles include electric automobiles, hybrid vehicles, fuel cell vehicles, and the like. Electric automobiles are driven by a battery as a power source. Hybrid vehicles are driven by a battery and an internal combustion engine as power sources. Fuel cell vehicles are driven by a fuel cell as a power source.

As shown in FIG. 1, the power device 10 includes, for example, a power storage device 11, a rotating electric machine 12, a power conversion unit 13, a noise filter 14, a relay 15, an AC charging and power supply unit 16, a DC-DC converter 18, an AC-DC converter 19, a power supply unit 21, a changeover switch 22, a first contactor 23, a second contactor 24, a capacitor 25, a diode 26, and a control device 27.

The power storage device 11 is, for example, a high-voltage battery that is a power source for a vehicle. The power storage device 11 includes a plurality of battery cells connected in series or in parallel. Each battery cell is, for example, a secondary battery such as a lead storage battery, a lithium ion battery, a nickel hydrogen battery, or an all-solid-state battery, a capacitor such as an electric double layer capacitor, or a composite battery formed through a combination of a secondary battery and a capacitor. Each battery cell is repeatedly charged and discharged.

The power storage device 11 transmits and receives power to and from the rotating electric machine 12 via the power conversion unit 13, which will be described below. The power storage device 11 is charged by a power source external to the vehicle (an external power source), and supplies power to the outside and inside of the vehicle.

The rotating electric machine 12 is, for example, a three-phase AC brushless DC motor. The rotating electric machine 12 includes a rotor having a permanent magnet for a field, and a stator having three-phase stator windings 12a that generate a rotating magnetic field for rotating the rotor. The three-phase stator windings 12a are connected to three-phase AC terminals 13c of the power conversion unit 13, which will be described below, and the three-phase noise filter 14, which will be described below.

The rotating electric machine 12 includes two contactors 12b connected to two combinations of the three-phase stator windings 12a. A first contactor 12b is connected between a first stator winding 12a and a second stator winding 12a of the three-phase stator windings 12a. A second contactor 12b is connected between the second stator winding 12a and a third stator winding 12a of the three-phase stator windings 12a. Each contactor 12b is set to turning on (conducting) during a powering operation and a regenerative operation of the rotating electric machine 12, and the three-phase stator windings 12a are set to a so-called star connection (a Y connection). Each contactor 12b is set to turning off (interrupting) during charging and power supply, which will be described below, and the three-phase stator windings 12a are separated from each other.

The rotating electric machine 12 generates a rotational driving force by performing a powering operation with the power supplied from the power conversion unit 13. For example, in a case where the rotating electric machine 12 can be connected to the wheels of a vehicle, the rotating electric machine 12 generates a running driving force by performing a powering operation with the power supplied from the power conversion unit 13. The rotating electric machine 12 may generate the power by performing a regenerative operation with the rotational power input from the wheels of the vehicle. In a case where the rotating electric machine 12 can be connected to an internal combustion engine of a vehicle, the rotating electric machine 12 may generate electricity with the motive power of the internal combustion engine.

The power conversion unit 13 is, for example, an inverter. The power conversion unit 13 performs conversion between DC power and AC power. The power conversion unit 13 is connected between the power storage device 11 and the rotating electric machine 12.

The power conversion unit 13 includes, for example, a bridge circuit formed of a plurality of switching elements and rectifying elements bridge-connected in three-phases. Each switching element is, for example, a transistor such as a SiC MOSFET. The plurality of switching elements are high side arm and low side arm transistors 13a and 13b that form a pair in each phase. A collector of the high side arm transistor 13a is connected to a positive electrode terminal 13p. An emitter of the low side arm transistor 13b is connected to a negative electrode terminal 13n. An emitter of the high side arm transistor 13a and a collector of the low side arm transistor 13b are connected to the stator winding 12a of the rotating electric machine 12 via the AC terminal 13c. The rectifying elements are, for example, reflux diodes connected in parallel in a forward direction from the emitter toward the collector between the collector and emitter of the transistors 13a and 13b. For example, in a case where the switching element is a MOSFET, by making a body diode of the switching element function as a reflux diode, the rectifying elements may be omitted.

The power conversion unit 13 controls the operation of the rotating electric machine 12 by transmitting and receiving power, for example, when the vehicle is running. For example, when the rotating electric machine 12 is powered, the power conversion unit 13 converts the DC power input from the positive electrode terminal 13p and the negative electrode terminal 13n into three-phase AC power on the basis of the power of the power storage device 11, and supplies the three-phase AC power to the rotating electric machine 12. The power conversion unit 13 generates a rotational driving force by sequentially commutating a current to the three-phase stator windings 12a of the rotating electric machine 12. For example, during regeneration of the rotating electric machine 12, the power conversion unit 13 converts the three-phase AC power input from the three-phase stator windings 12a into DC power by turning on (conducting) and turning off (interrupting) the switching elements of each phase synchronized with the rotation of the rotating electric machine 12. The power conversion unit 13 can supply the DC power converted from three-phase AC power to the power storage device 11 via the DC-DC converter 18, which will be described below.

The rotating electric machine 12 and the power conversion unit 13 operate as a so-called three-phase or single-phase full bridgeless type (or bridgeless and totem pole type) power factor correction (PFC) circuit during charging and power supply, which will be described below, while the vehicle is stopped, for example. A so-called bridgeless PFC is a PFC that does not include a bridge rectifier with a plurality of diodes connected in a bridge. A so-called totem pole PFC is a PFC that includes a pair of switching elements of the same conductivity type that are connected in series in the same direction (a totem pole connection).

The three-phase stator winding 12a of the rotating electric machine 12, which functions as an inductor, and the three-phase bridge circuit of the power conversion unit 13 perform voltage conversion through, for example, so-called three-phase or two-phase interleaving. The periods of the three-phase switching control are sequentially shifted by 1/3 period (120 degrees) in an appropriate order. The periods of the two-phase switching control are shifted from each other by a half period.

The noise filter 14 is, for example, an electro magnetic compatibility (EMC) filter or the like. The noise filter 14 is connected between the three-phase stator winding 12a of the rotating electric machine 12 and the relay 15.

The relay 15 is, for example, a three-phase relay. The relay 15 is connected between the noise filter 14 and the AC charging and power supply unit 16.

The AC charging and power supply unit 16 includes, for example, a connector for AC power of a predetermined standard. The predetermined standard is, for example, a three-phase four-wire system or the like with a predetermined nominal voltage. For example, in the case of a three-phase four-wire system, the three phases are connected to the relay 15, and the N phase is connected to a connection point between the two diodes 26, which will be described below. The AC charging and power supply unit 16 is connected to the external AC power source, for example, during charging (AC charging) while the vehicle is stopped. The external AC power source is, for example, a commercial power source connected to a power system. For example, during power supply while the vehicle is stopped (AC power supply), the AC charging and power supply unit 16 is not connected to the external power source and supplies power to the outside with the power of the power storage device 11.

The DC-DC converter 18 is a DC-DC converter that converts a DC voltage in both directions, for example, step-up and step-down. The DC-DC converter 18 is, for example, an isolated bidirectional DC-DC converter such as a dual active bridge (DAB) converter. The DC-DC converter 18 includes, for example, a bridge circuit formed of a plurality of switching elements bridge-connected in two phases to each of a primary side and a secondary side of a pair of inductors.

The DC-DC converter 18 is connected, for example, between a first positive electrode terminal 18p and a first negative electrode terminal 18n, and a second positive electrode terminal 19p and a second negative electrode terminal 19n via the changeover switch 22, which will be described below. The first positive electrode terminal 18p and the first negative electrode terminal 18n are connected to a positive electrode terminal and a negative electrode terminal of the power storage device 11. The second positive electrode terminal 19p and the second negative electrode terminal 19n are connected to the positive electrode terminal 13p and the negative electrode terminal 13n of the power conversion unit 13.

The AC-DC converter 19 includes, for example, a so-called full bridgeless type (or bridgeless and totem pole type) power factor correction (PFC) circuit that converts DC power into AC power. DC terminals of the AC-DC converter 19 are connected to the second positive electrode terminal 19p and the second negative electrode terminal 19n via the changeover switch 22, which will be described below. AC terminals of the AC-DC converter 19 are connected to the power supply unit 21.

The power supply unit 21 includes, for example, a connector for AC power of a predetermined standard. For example, during charging while the vehicle is stopped, the power supply unit 21 supplies power to the outside with power from the external power source connected to the AC charging and power supply unit 16. For example, when power is supplied while the vehicle is stopped or when the vehicle is running, the power supply unit 21 supplies power to the outside with the power of the power storage device 11.

The changeover switch 22 switches the connection between the DC-DC converter 18 and each of the power conversion unit 13 and the AC-DC converter 19. For example, during charging and power supply while the vehicle is stopped, the changeover switch 22 connects the DC-DC converter 18 to each of the power conversion unit 13 and the AC-DC converter 19. For example, when the vehicle is running, the changeover switch 22 connects the DC-DC converter 18 to the AC-DC converter 19.

The two first contactors 23 are connected between the first positive electrode terminal 18p and the second positive electrode terminal 19p of the DC-DC converter 18, and between the first negative electrode terminal 18n and the second negative electrode terminal 19n of the DC-DC converter 18.

The two second contactors 24 are connected between the first positive electrode terminal 18p of the DC-DC converter 18 and the positive electrode terminal of the power storage device 11, and between the first negative electrode terminal 18n of the DC-DC converter 18 and the negative electrode terminal of the power storage device 11.

A capacitor 25 is connected between the first positive electrode terminal 18p and the first negative electrode terminal 18n of the DC-DC converter 18. The capacitor 25 smooths voltage fluctuations that occur when each switching element of the DC-DC converter 18 is turned on (conducted) and turned off (interrupted).

The two diodes 26 are connected in series between the positive electrode terminal 13p and the negative electrode terminal 13n of the power conversion unit 13.

The control device 27 controls the power device 10 in an integrated manner, for example. The control device 27 is a software functional unit that functions by executing a predetermined program by a processor such as a central processing unit (CPU). The software functional unit is an ECU that includes a processor such as a CPU, a read only memory (ROM) that stores a program, a random access memory (RAM) that temporarily stores data, and an electronic circuit such as a timer. At least a portion of the control device 27 may be an integrated circuit such as a large scale Integration (LSI).

For example, the control device 27 generates a control signal that indicates the timing for turning on (conducting) and turning off (interrupting) each switching element, and generates a gate signal for actually turning on (conducting) and turning off (interrupting) each switching element on the basis of the control signal. For example, the control device 27 performs power factor improvement while converting the power and the voltage by controlling switching of each switching element of the power conversion unit 13, the DC-DC converter 18, and the AC-DC converter 19.

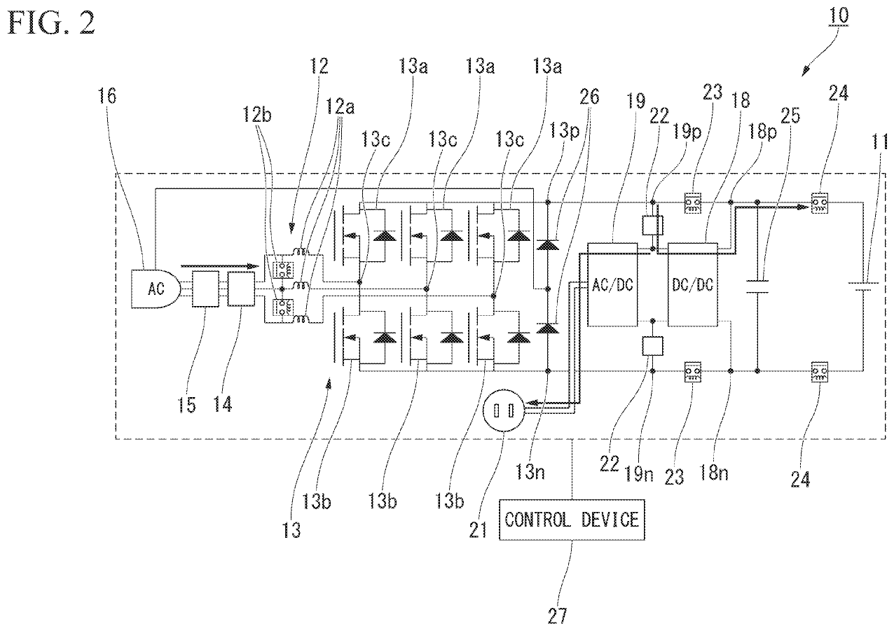

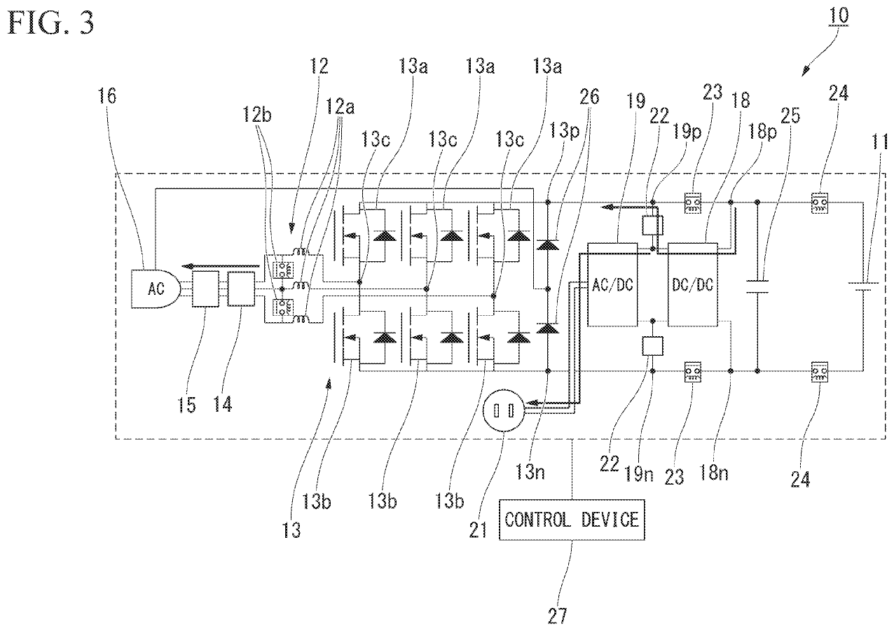

FIG. 2 is a diagram showing an AC charging state of the power device 10 according to the embodiment. FIG. 3 is a diagram showing an AC power supply state of the power device 10 according to the embodiment.

As shown in FIG. 2, for example, during AC charging in which the power storage device 11 is charged with AC power from the AC charging and power supply unit 16 while the vehicle is stopped, the control device 27 operates the rotating electric machine 12 and the power conversion unit 13 as the power factor correction (PFC) circuit. While improving the power factor, the control device 27 converts AC power into DC power, and steps up a predetermined AC nominal voltage (for example, from 100 V to 240 V, or the like) into a predetermined DC power (for example, from 650 V to 800 V, or the like) higher than the voltage of the power storage device 11.

For example, the control device 27 connects the power conversion unit 13 and the DC-DC converter 18 to each other using the changeover switch 22, and causes the DC-DC converter 18 to perform a voltage step-down operation. The control device 27 steps down (rectifies or adjusts) a predetermined DC voltage (for example, from 650 V to 800 V, or the like) into a predetermined target DC voltage (for example, from 240 V to 400 V, or the like) suitable for charging the power storage device 11 using the DC-DC converter 18. For example, the control device 27 sets the voltage on the input side of the DC-DC converter 18 to be higher than the voltage on the output side of the DC-DC converter 18.

For example, the control device 27 connects the power conversion unit 13 and the AC-DC converter 19 to each other using the changeover switch 22, and causes the AC-DC converter 19 to perform power conversion and a voltage step-down operation. While improving the power factor, the control device 27 converts DC power into AC power, and steps down (rectifies or adjusts) a predetermined DC voltage (for example, from 650 V to 800 V, or the like) into a predetermined AC power (for example, from 100 V to 240 V, or the like) suitable for the predetermined standard of the power supply unit 21.

As shown in FIG. 3, for example, during AC power supply in which AC power is supplied from the power storage device 11 to the AC charging and power supply unit 16 while the vehicle is stopped, the control device 27 connects the power conversion unit 13 and the DC-DC converter 18 to each other using the changeover switch 22, and causes the DC-DC converter 18 to perform a voltage step-down operation. The control device 27 steps down (rectifies or adjusts) a predetermined DC voltage (for example, from 240 V to 400 V, or the like) of the power storage device 11 into a predetermined nominal DC voltage (for example, from 100 V to 400 V, or the like) using the DC-DC converter 18. For example, the control device 27 sets the voltage on the input side of the DC-DC converter 18 to be higher than the voltage on the output side of the DC-DC converter 18.

The control device 27 operates the rotating electric machine 12 and the power conversion unit 13 as the power factor correction (PFC) circuit. While improving the power factor, the control device 27 converts DC power into AC power, and converts a predetermined DC nominal voltage (for example, from 100 V to 400 V, or the like) into a predetermined AC nominal voltage (for example, from 100 V to 240 V, or the like).

For example, the control device 27 connects the power conversion unit 13 and the AC-DC converter 19 to each other using the changeover switch 22, and causes the AC-DC converter 19 to perform power conversion and a voltage step-down operation. While improving the power factor, the control device 27 converts DC power into AC power, and steps down (rectifies or adjusts) a predetermined DC nominal voltage (for example, from 100 V to 400 V, or the like) into a predetermined AC power (for example, from 100 V to 240 V, or the like) suitable for the predetermined standard of the power supply unit 21.

As described above, according to the power device 10 of the embodiment, the rotating electric machine 12 and the power conversion unit 13, which stop operating when the vehicle is stopped during AC charging and AC power supply, are operated as the power factor correction (PFC) circuit. Therefore, it is possible to suppress the device configuration from becoming complicated. By providing the DC-DC converter 18 whose connection to each of the power conversion unit 13 and the AC-DC converter 19 is switched at each of the times when charging and supplying power while the vehicle is stopped, when the vehicle is running, and the like, the operation of power supply by the power supply unit 21 can be properly ensured at each of the times when charging and supplying power by the AC charging and power supply unit 16.

By independently operating the step-up and AC-DC conversion of the power from outside the vehicle and the step-down and DC-AC conversion of the power to the power supply unit 21 by the rotating electric machine 12 and the power conversion unit 13, the power can be supplied to the outside via the power supply unit 21 even during AC charging from outside the vehicle via the AC charging and power supply unit 16. By independently operating the step-down and AC-DC conversion of the power from the DC-DC converter 18 and the step-down and DC-AC conversion of the power to the power supply unit 21 by the rotating electric machine 12 and the power conversion unit 13, the power can be supplied to the outside via the power supply unit 21 even during AC power supply to the outside of the vehicle via the AC charging and power supply unit 16.

Charging of the power storage device 11 from the external power source or the like is performed by the AC charging and power supply unit 16 via the rotating electric machine 12, the power conversion unit 13, and the DC-DC converter 18, and power supply from the power storage device 11 to the outside is performed by each of the AC charging and power supply unit 16 and the power supply unit 21 via the DC-DC converter 18. Power can be supplied by the power supply unit 21 both during charging and power supply by the AC charging and power supply unit 16, and it is possible to ensure proper charging and power supply operations while suppressing the complexity of the device configuration.

Since the DC-DC converter 18 sets a voltage suitable for charging the power storage device 11 through the voltage step-down operation, the charging power amount can be increased by relatively increasing the input voltage of the DC-DC converter 18.

With the voltage obtained through the voltage step-up operation of the rotating electric machine 12 and the power conversion unit 13, the power storage device 11 can be charged after the voltage is stepped down via the DC-DC converter 18, the voltage can be stepped down by the AC-DC converter 19, the power can be supplied by the power supply unit 21, and it is possible to properly ensure the charging operation by the AC charging and power supply unit 16 and the power supply operation by the power supply unit 21.

Since the DC-DC converter 18 sets a voltage suitable for the input to the rotating electric machine 12 and the power conversion unit 13 through the voltage step-down operation, the amount of power supplied can be increased by relatively increasing the input voltage of the DC-DC converter 18.

With the voltage obtained through the voltage step-down operation of the DC-DC converter 18, the power can be supplied from the AC charging and power supply unit 16 to the outside after the voltage is stepped down via the rotating electric machine 12 and the power conversion unit 13, the voltage can be stepped down by the AC-DC converter 19, the power can be supplied by the power supply unit 21, and it is possible to properly ensure the power supply operation by each of the AC charging and power supply unit 16 and the power supply unit 21.

The embodiments of the present invention are presented by way of examples and are not intended to limit the scope of the invention. These embodiments can be implemented in various other forms, and various omissions, substitutions, and changes can be made without departing from the gist of the invention. These embodiments and their modifications are included within the scope and gist of the invention as well as within the scope of the invention described in the claims and its equivalents.

What is claimed is:

1. A power device comprising:
a power storage unit;
a rotating electric machine;
a charging and power supply unit connected to the rotating electric machine;
a DC voltage conversion unit connected to the power storage unit;
a power conversion unit connected between the DC voltage conversion unit and the rotating electric machine; and
a power supply unit connected to the DC voltage conversion unit and the power conversion unit.

2. The power device according to claim 1, wherein, in a case where the power storage unit is charged from the charging and power supply unit by an external power source, the rotating electric machine and the power conversion unit perform a voltage step-up operation, and the DC voltage conversion unit performs a voltage step-down operation.

3. The power device according to claim 2, wherein, in a case where the power storage unit is charged from the charging and power supply unit by an external power source, the power supply unit steps down a voltage obtained through the voltage step-up operation of the rotating electric machine and the power conversion unit and supplies power to the outside.

4. The power device according to claim 1, wherein, in a case where power is supplied to the outside from the charging and power supply unit with power of the power storage unit, the rotating electric machine, the power conversion unit, and the DC voltage conversion unit perform a voltage step-down operation.

5. The power device according to claim 4, wherein, in a case where power is supplied to the outside from the charging and power supply unit with power of the power storage unit, the power supply unit steps down a voltage obtained through the voltage step-down operation of the DC voltage conversion unit and supplies power to the outside.
